(19) United States
(12) Patent Application Publication
(10) Pub. No.: US 2013/0228146 A1
(43) Pub. Date: Sep. 5, 2013

(54) INTAKE TRACT AIRFLOW ENHANCEMENT DEVICE

(71) Applicant: Don EMLER, Rancho Dominguez, CA (US)

(72) Inventor: Don EMLER, Rancho Dominguez, CA (US)

(21) Appl. No.: 13/779,786

(22) Filed: Feb. 28, 2013

Related U.S. Application Data
(60) Provisional application No. 61/605,420, filed on Mar. 1, 2012.

(51) Int. Cl. F02M 35/10

(52) U.S. Cl. CPC F02M 35/10
USPC 123/184.21

(57) ABSTRACT

A device of dividing the intake tract of an engine system positioned upstream from the throttle plate that optionally has holes in at least one divider section and functions to enhance airflow from the air source to the throttle plate.

### BACKGROUND OF THE INVENTION

In most engines, an air filtering device secures to an air filter holding device, for example, an airbox. An intake tract conduit, for example, a tube or velocity stack, enters the air filter holding device and joins the throttle body or carburetor with the air flowing in through the air filter.

The area of the air filter is much larger than the throat size of the throttle body or carburetor and as a result, as the air passes through the filter the velocity is low. The air speeds up as it gets constricted in the smaller throat of the throttle body or carburetor. It is desirable to maximize the air speed and volume delivered to the throttle plate from the intake tract. The current invention is directed to maximizing the air velocity through the intake tract conduit and to maximizing the volume of air delivered to the throttle plate for any given period of time.

There is a need in the market place for such an invention. WO 02/37009, for example, fails to either maximize the air velocity through the intake tract conduit or to maximize the volume of air delivered to the throttle plate for any given period of time. WO 02/37009 provides a plate perforated with many small holes and is positioned downstream of the throttle plate. Similarly, U.S. Pat. No. 5,588,635, U.S. Pat. No. 5,722,357, and U.S. Pat. No. 5,193,583 also fail to address the problems recognized by the current invention or provide the benefits of the current invention.

### SUMMARY OF THE INVENTION

The present invention includes an adapter device which functions to increase the rate of air flow from the air source to the throttle plate of an air intake system of an internal combustion engine. The invention comprises dividers that can be placed between the inside of the air filter and the end of the intake tract tube of an air intake system of an internal combustion engine. A divider consisting of one plate would divide this area into two sections. Multiple dividers, such as ones that cross each other or plates that run parallel to each other, or any combination of dividers, which create four or more sections, are included in this invention. In some embodiments the intake tract has at least one divider with multiple holes with a diameter of 25% to 75% of the height of the divider. In some embodiments, dividers do not intersect each other. In some embodiments the diameter of the holes are 0.2 inches or larger.

The dividers are preferably thin plates of a generally rectangular shape (length greater than width) that optionally have large holes in them. In some embodiments, the dividers have a thickness from 0.01 to 0.1 inches. One or both of the short sides of the rectangular shape defining the width of the dividers may be configured to attach to an intake tract. In some embodiments, one or more of the dividers are configured in a fin shape on the short side facing the entrance of the intake tract (where air from the air source meets the intake tract). In addition to providing a means for attachment, the short sides defining the width of the dividers may be configured to further define the air flow. In some embodiments at least one of the short sides of the dividers defining its width is angled inward and the edge can be either straight (sharp) or curved. In some of the embodiments, the edges of each divider are curved.

Bernoulli's principal states that an increase in the speed of the air results in a simultaneously decrease in pressure or a decrease in the airs potential energy. Thus air speed is increased when passing from the air filter to the throttle body or carburetor as the air filter is much larger in volume than the intake tract of the throttle body or carburetor. Because of this size difference, the velocity of the incoming air is very low as the air passes through the filter, but speeds up as it is constricted by the intake track along the way to the smaller throat of the throttle body or carburetor.

By dividing the intake tract into sections with the dividers of the embodiment of the current invention, the pressure in each one of these sections is further increased leading to an increased velocity of the air moving through the intake tract. The holes in the dividers act to balance the air pressure between each section of the intake tract maximizing air velocity through each section of the intake tract. This leads to an over all increase in the volume of air delivered from the air source (air filter/air intake) to the throttle plate in any given time period. This effect is most efficient from about ⅛ to ½ throttle.

The holes in the dividers have a diameter that is the same or smaller than the smallest diameter of the throttle body or carburetor. In the preferred embodiment the holes are round or ovular. In some embodiments the holes have a minimum diameter of 0.2 inches. Holes with a diameter of under 0.2 inches fail to act to balance the air pressure difference between each section of the intake tract. Therefore, dividers with holes less than 0.2 inches in diameter will not function as the embodiments of the current application with holes that are greater than 0.2 inches in diameter. Holes that are greater than 0.2 inches in diameter, however, do not inherently improve noise reduction over holes that are less than 0.2 inches in diameter.

In some embodiments the minimum diameter of the holes is from 25% to 75% of the height of its associated divider section, but never less than 0.2 inches in diameter.

In some embodiments the holes can be in a shape, for example, triangular, square, star shaped, or octagon. They can also be in the shape of a symbol such as an emblem or logo. For the purposes of this invention the minimum diameter refers to the smallest distance from one side of a shape to the other side of a shape. For example, in a star shaped hole, the minimum diameter would be from an inner point on one side to the inner point directly across from it.

In some embodiments, the total open surface area of the holes is the same or a larger than the smallest diameter of the throttle body or carburetor. This is the preferred measurement for irregular shape or symbols, or for shapes with near zero minimum diameters, for example, a triangle.

The device can be made from any solid material. In some embodiments it is made of metal. In some embodiments it is made from a hard solvent resistant plastic.

In the preferred embodiments of the current application, the device is positioned upstream from the throttle plate.

In the preferred embodiments, the dividers are arranged perpendicular to each other forming a (t) shape in cross section.

In some embodiments, the dividers have at least one hole that allows air to pass through.

In some embodiments, the dividers do not have holes.

In some embodiments, a portion of one end of the dividers has a fin shape. In some embodiments the fins of one or more sections of the dividers can be of different lengths and/or configurations. In the preferred embodiments, all the fins are on the same end of the dividers. In the some embodiments all of the divider sections have fins. In some embodiments, the fins are different lengths. In some embodiments the fin of one divider section is longer than the other finned or none finned divider sections. In some embodiments less than all of the divider sections have fins. In some embodiments, only one of the divider sections has finds.

In some embodiments, the holes of the dividers have a diameter of at least 0.2 inches.

In some embodiments, the holes of the divider have a diameter of between 25% and 75% of the height of the section of the divider where it is positioned.

In some embodiments, the holes on each section on a divider are positioned in the same way.

In some embodiments, the holes are positioned in the vertical center of their respective divider sections.

In some embodiments each divider section has exactly 4 holes. In some of these embodiments, the four holes are positioned the same way on each of the dividers so that if the divider where stacked on top of each other the holes would line up. In some of these embodiments, the holes are staggered. In some embodiments, at least two divider sections have exactly 4 holes and wherein the holes of each divider section with holes are positioned the same way. In some embodiments, the holes are an equal distance from each other. In some embodiments, the holes are an equal distance from a top and bottom of their respective divider sections.

In some embodiments, the dividers have more than four holes or less than 4 holes. In some embodiments, the number of holes in each divider is determined independently, and each divider can have the same amount of holes as any other divider or a different amount of holes than any other divider.

In a preferred embodiment at least two dividers bisect each other at a divider intersection point, resulting in at least four divider sections and are adapted to fit inside an intake tract upstream of a throttle plate of air intake system of an internal combustion engine.

### BRIEF DESCRIPTION OF THE DRAWINGS

FIG. 1 illustrates an embodiment of the application with four divider sections and no holes.

FIG. 2 illustrates another embodiment of the application with fins on one side of the dividers and no holes.

FIG. 3 illustrates another embodiment of the application installed in an intake track.

FIG. 4 illustrates another embodiment of the application with holes and one fin.

FIG. 5 illustrates another embodiment of the application with holes installed in an intake track in an engine system.

### DETAILED DESCRIPTION OF THE DRAWINGS

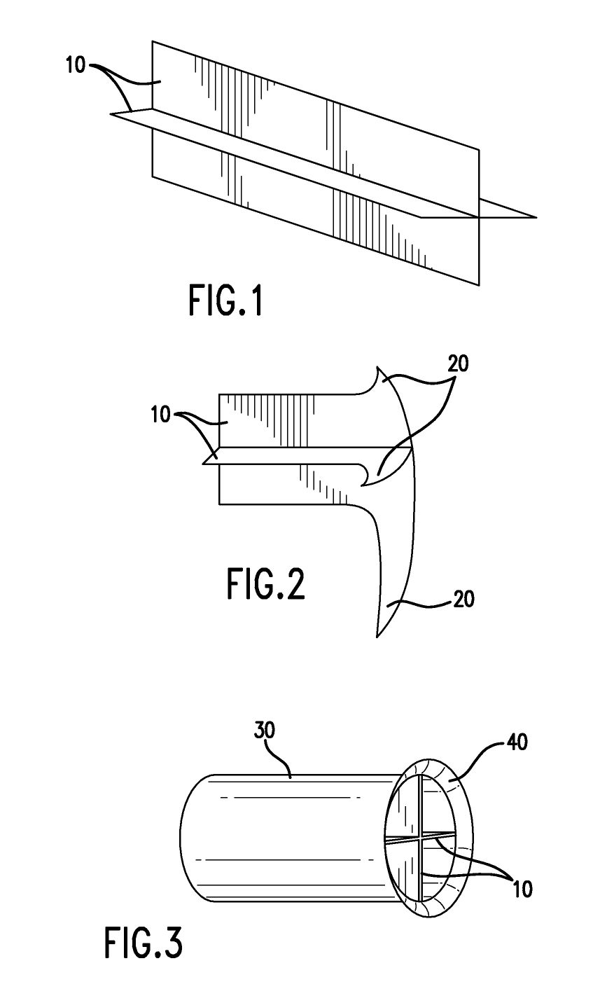

FIG. 1 illustrates an embodiment where the dividers (10) are arranged perpendicular to each other forming a (t) shape in cross section also referred to as a two plate crossover design.

FIG. 2 illustrates another two plate crossover embodiment where one side of the dividers (10) is configured to fit a specially shaped air filter holding device or intake track. One end of the dividers are configured in fin shape (2) to fit a specially shaped air filter holding device or intake track.

FIG. 3 illustrates another two plate crossover embodiment where dividers (10) are inside of a round intake tract (30) that has a small velocity stack shape (40) on the incoming air side.

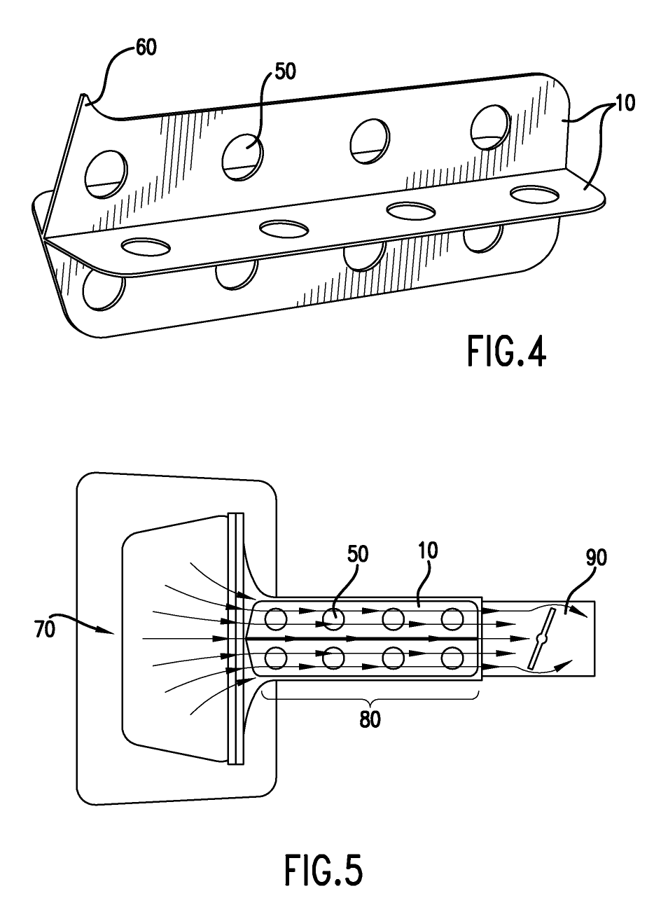

FIG. 4 illustrates another two plate crossover embodiment where each divider (10) has 4 holes (50). One of the 4 dividers has a fin (60) on the short side that will face the air source once instated. The fin (60) will function to secure the device on the intake tract (80).

FIG. 5 illustrates another two plate crossover embodiment installed in an intake track. The air source (70) feed air to the intake track (80). The device fits inside the intake tract (80) dividing it into 4 sections. The air from the air source (70) enters each of the four sections of the intake tract (80) and is accelerated to the throttle plate (90). Air is allowed to pass through the holes (50) in the dividers (10) to equalize the air pressure in each section of the intake tract (80) and maximize air movement through the intake tract.

1. An adapter device comprising:
at least two dividers that bisect each other at a divider intersection point, resulting in at least four divider sections and are adapted to fit inside an intake tract of the air intake system of an internal combustion engine upstream of a throttle plate.

2. The device of claim 1 wherein at least one of the divider sections has multiple holes.

3. The device of claim 2 wherein each hole creates a total open surface area in the divider section that is greater than or equal to the smallest diameter of an associated throttle body or carburetor.

4. The device of claim 2 wherein each hole has a minimum diameter of 0.2 inches.

5. The device of claim 2 wherein each hole has a minimum diameter of from 25% to 75% of the height of its associated divider section but never less than 0.2 inches.

6. The device of claim 2 wherein at least one divider section has exactly 4 holes.

7. The device of claim 6 wherein every divider section has exactly 4 holes.

8. The device of claim 6 wherein at least two divider sections have exactly 4 holes and wherein the holes of each divider section are positioned the same way.

9. The device of claim 6 wherein the holes are an equal distance from each other.

10. The device of claim 6 wherein the holes are an equal distance from a top and bottom of their respective divider sections.

11. The device of claim 1 wherein one side of the device has at least one divider section with a fin.

12. The device of claim 11 wherein one divider section has a fin that is longer than the other finned or non-finned divider sections.

13. The device of claim 11 wherein the at least one divider section with a fin is capable of attaching to an intake tract or air filter holding device in an engine.

14. The device of claim 1 wherein one side of an end of at least one divider section angles inward so that the portions of the divider section that are closer to the divider intersection point and extend further than portions of the divider section that are further from the divider intersection point.

15. The device of claim 1 wherein a corner of the side of each divider section that is further from the divider intersection point is curved.

16. An intake tract adapter device comprising:
at least one divider with multiple holes with a diameter of 25% to 75% of the height of the divider adapted to fit inside an intake tract of the air intake system of an internal combustion engine upstream of a throttle plate.

17. The device of claim 16 wherein the dividers do not intersect each other.
